(19) United States
(12) Patent Application Publication
(10) Pub. No.: US 2025/0201979 A1
(43) Pub. Date: Jun. 19, 2025

(54) ELECTRICITY STORAGE APPARATUS

(71) Applicant: TOYOTA JIDOSHA KABUSHIKI KAISHA, Aichi-ken (JP)

(72) Inventors: Kodai SHINTANI, Toyota-shi (JP); Satoshi MORIOKA, Okazaki-shi (JP); Seita IWAHASHI, Handa-shi (JP); Yuusuke NOSE, Toyohashi-shi (JP); Yuya SAEKI, Kariya-shi (JP); Takayuki HIROSE, Kariya-shi (JP); Tomohiro NAKAMURA, Kariya-shi (JP)

(21) Appl. No.: 18/976,337

(22) Filed: Dec. 11, 2024

(30) Foreign Application Priority Data
Dec. 15, 2023 (JP) 2023-212060

(51) Int. Cl. H01M 50/14; H01M 50/119; H01M 50/121; H01M 50/128; H01M 50/129; H01M 50/131

(52) U.S. Cl. CPC H01M 50/14; H01M 50/119; H01M 50/121; H01M 50/128; H01M 50/129; H01M 50/131

(57) ABSTRACT

An electricity storage apparatus includes: an electricity storage module; and an exterior body that houses the electricity storage module. The electricity storage module includes a stacked electrode body; a main surface; and a peripheral surface. The main surface has: a plurality of first corner portions; and a plurality of edge portions. The peripheral surface has a plurality of end surfaces. Each end surface has a plurality of second corner portions. The exterior body includes: a laminate sheet; and a plurality of protection sheets. The laminate sheet has: a main wall portion that covers each first corner portion and each edge portion; and a peripheral wall portion. Each protection sheet is provided in a position corresponding to the first corner portion and the plurality of second corner portions each connected to the first corner portion out of a border region between the main wall portion and the peripheral wall portion.

### CROSS-REFERENCE TO RELATED APPLICATION

This application claims priority to Japanese Patent Application No. 2023-212060 filed on Dec. 15, 2023, incorporated herein by reference in its entirety.

### BACKGROUND

### 1. Technical Field

The present disclosure relates to an electricity storage apparatus.

### 2. Description of Related Art

Hitherto, various electricity storage apparatuses have been known. Japanese Unexamined Patent Application Publication No. 2004-134210 (JP 2004-134210 A) discloses a bipolar stack-type battery as one example of an electricity storage apparatus. In the stack-type battery, sheet-like electrodes are stacked across an electrolyte layer. In the stack-type battery, the electrodes are stacked in outermost layers of a stack such that current collectors included in the electrodes are exposed to the outside of the battery in the stacking direction of the electrodes and function as terminals.

In detail, each of the current collectors of the two electrodes in the outermost layers is covered by a laminate sheet in which an opening is provided in the center. Four edges of each laminate sheet are sealed, and a rim of an opening of each laminate sheet is attached to a current collector by seal resin. As a result, four edges of the electrolyte layer and a bipolar electrode are depressurized and hermetically sealed. As each laminate sheet, a polymeric metal composite film in which a heat-fusible resin film, a metal foil, and a resin film that has rigidity are stacked in the stated order is used.

### SUMMARY

In JP 2004-134210 A, a plurality of electrodes is sandwiched between each of the laminate sheets from the stacking direction, and hence a drawing process is applied to each of the laminate sheets in advance. Each of the laminate sheets is bent to the direction of a laminate sheet on the counterpart side at a place near peripheral edge portions of the two electrodes in outermost layers by the drawing process.

When a thermal shock is applied to such a stack-type battery due to a rapid temperature change, there is a fear that metallic foils of the laminate sheets may be torn at sections that are bent as described above. When the metallic foils are torn, the sealing property of the stack-type battery obtained by the laminate sheets is lost.

Thus, the present disclosure provides an electricity storage apparatus capable of maintaining the sealing property of a stack-type battery even when a thermal shock is applied.

According to an aspect of the present disclosure, an electricity storage apparatus includes: an electricity storage module having a stacked electrode body in which a plurality of electrodes is stacked in a predetermined direction; and an exterior body that houses the electricity storage module. The electricity storage module includes: a main surface of which a normal direction is the predetermined direction; and a peripheral surface extending from the main surface in the predetermined direction. The main surface has: a plurality of first corner portions; and a plurality of edge portions each sandwiched between two of the first corner portions. The peripheral surface has a plurality of end surfaces consecutive in a peripheral direction of the electricity storage module. Each of the end surfaces has a plurality of second corner portions each connected to a different one of the first corner portions. The exterior body includes: a laminate sheet having a metal layer; and a plurality of protection sheets each welded to the laminate sheet. The laminate sheet has: a main wall portion that covers each of the first corner portions and each of the edge portions; and a peripheral wall portion that covers each of the end surfaces. Each of the protection sheets is provided in a position corresponding to the first corner portion and the plurality of second corner portions each connected to the first corner portion out of a border region between the main wall portion and the peripheral wall portion.

According to such configuration, the protection sheet is provided in a nook position corresponding to the first corner portion and the plurality of second corner portions each connected to the first corner portion out of the border region between the main wall portion and the peripheral wall portion. Therefore, even when a crack occurs in a metal layer of the laminate sheet due to a thermal shock, the sealing property in the nook position can be ensured. Therefore, even when a thermal shock is applied to the electricity storage apparatus, the sealing property of the electricity storage apparatus can be maintained.

Each of the protection sheets may be a resin barrier film stronger to a thermal shock than the metal layer and may be covered with the laminate sheet.

According to such configuration, an electrolytic solution injected into the electricity storage module can be prevented from entering the laminate.

According to the present disclosure, it becomes possible to maintain the sealing property of the stack-type battery even when a thermal shock is applied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a stack-type battery;

FIG. 2 is a sectional view taken along line II-II shown in FIG. 1;

FIG. 3 is a sectional view taken along line III-III shown in FIG. 1;

FIG. 4 is a perspective view of a structure body;

FIG. 5 is a perspective view of an electricity storage module;

FIG. 6 is a sectional view taken along line VI-VI shown in FIG. 1;

FIG. 7 is a sectional view taken along line VI-VI shown in FIG. 1 after a thermal shock is applied;

FIG. 8A is a view for describing a manufacturing method of a first laminate sheet portion;

FIG. 8B is a view for describing the manufacturing method of the first laminate sheet portion;

FIG. 8C is a view for describing the manufacturing method of the first laminate sheet portion;

FIG. 8D is a view for describing the manufacturing method of the first laminate sheet portion;

FIG. 8E is a view for describing the manufacturing method of the first laminate sheet portion;

FIG. 8F is a view for describing the manufacturing method of the first laminate sheet portion;

FIG. 8G is a view for describing the manufacturing method of the first laminate sheet portion;

FIG. 8H is a view for describing the manufacturing method of the first laminate sheet portion;

FIG. 9A is a view for describing a method of manufacturing the stack-type battery by the electricity storage module and an exterior body;

FIG. 9B is a view for describing the method of manufacturing the stack-type battery by the electricity storage module and the exterior body;

FIG. 9C is a view for describing the method of manufacturing the stack-type battery by the electricity storage module and the exterior body; and

FIG. 9D is a view for describing the method of manufacturing the stack-type battery by the electricity storage module and the exterior body.

### DETAILED DESCRIPTION OF EMBODIMENTS

An embodiment of the disclosure is described in detail below with reference to the drawings. In the embodiment described below, the same or common parts are denoted by the same reference characters in the drawings and the description thereof is not repeated.

As one example of an electricity storage apparatus, a stack-type battery is described as an example below. The stack-type battery is mounted on electrified vehicles such as a hybrid electric vehicle that travels with use of a motive power of at least one of a motor and an engine and an electric vehicle that travels by a driving force acquired by electrical energy.

The stacking direction of electrodes in the stack-type battery is also referred to as a “DR3 direction” below. A direction that is perpendicular to the stacking direction and is the short direction of the stack-type battery is also referred to as a “DR1 direction”. A direction that is perpendicular to the stacking direction and is the longitudinal direction of the stack-type battery is also referred to as a “DR2 direction”. The DR1 direction, the DR2 direction, and the DR3 direction are orthogonal to each other.

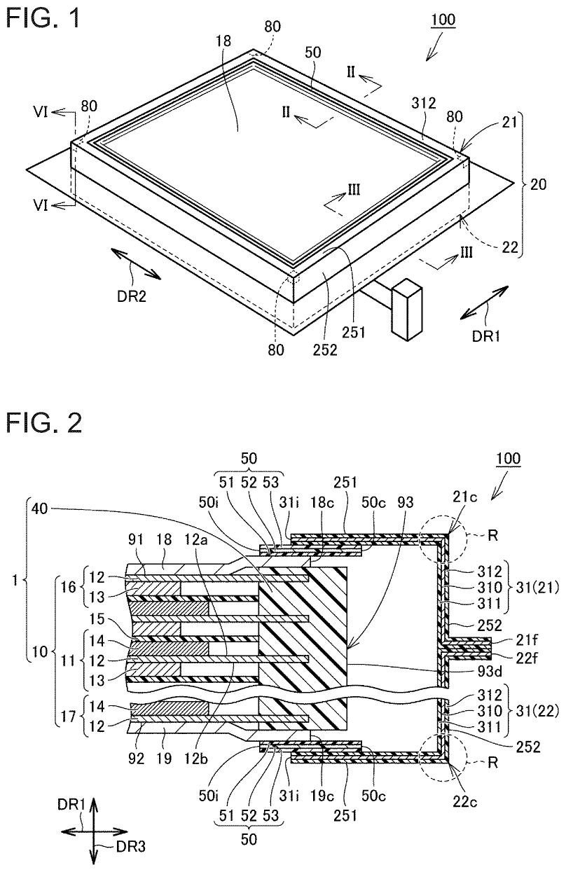

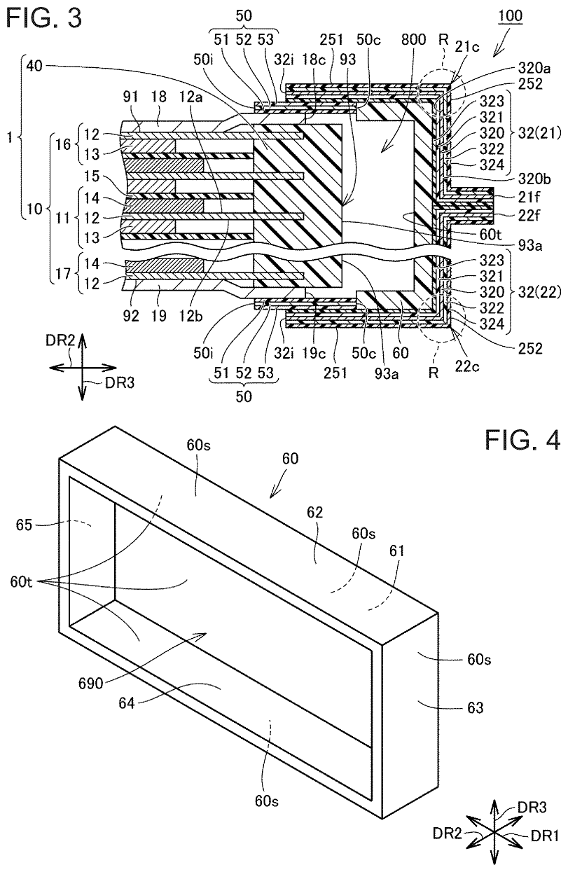

FIG. 1 is a perspective view of a stack-type battery according to an embodiment of the present disclosure. FIG. 2 is a sectional view taken along line II-II shown in FIG. 1. FIG. 3 is a sectional view taken along line III-III shown in FIG. 1. With reference to FIG. 1 to FIG. 3, a stack-type battery 100 according to the present embodiment is described.

As shown in FIG. 1 to FIG. 3, the stack-type battery 100 includes an electricity storage module 1 having a resin sealing body 40 and a stacked electrode body 10 in which a plurality of electrodes (electrode plates 11) described later are stacked in the stacking direction, a structure body 60 (FIG. 3), and an exterior body 20 that houses the electricity storage module 1 and the structure body 60.

The electricity storage module 1 further has a first main surface 91, a second main surface 92 on the side opposite from the first main surface 91, and peripheral surfaces 93. The first main surface 91 and the second main surface 92 are end surfaces in the DR3 direction. The first main surface 91 and the second main surface 92 are parallel to each other. The first main surface 91 and the second main surface 92 are surfaces that spread in the DR1 direction and the DR2 direction. The first main surface 91 is a surface in contact with a first conductive plate 18 described later. The second main surface 92 is a surface in contact with a second conductive plate 19 described later.

The peripheral surfaces 93 are surfaces perpendicular to the first main surface 91 and the second main surface 92. In this example, the peripheral surfaces 93 are configured by four end surfaces 93a to 93d (see FIGS. 2, 3, and 7). Each of the end surfaces 93a to 93d is a side surface of the resin sealing body 40. In this example, each of the end surfaces 93a to 93d is a planar surface having a rectangular shape.

The exterior body 20 is electrically connected to a terminal end electrode of the stacked electrode body 10 described later and is provided such that current can be taken to the outside from the stacking direction. The exterior body 20 includes the first conductive plate 18, the second conductive plate 19, a first laminate sheet portion 21, a second laminate sheet portion 22, a resin sheet 50, and eight protection sheets 80. The stack-type battery 100 is a secondary battery such as a lithium ion battery, for example.

In FIG. 1, out of the eight protection sheets 80, four protection sheets 80 on the first laminate sheet portion 21 side are shown. The remaining four protection sheets 80 are positioned on the second laminate sheet portion 22 side. The four protection sheets 80 on the first laminate sheet portion 21 side and the four protection sheets 80 on the second laminate sheet portion 22 side are positioned to face each other in the DR3 direction. The four protection sheets 80 on the first laminate sheet portion 21 side and the four protection sheets 80 on the second laminate sheet portion 22 side are positioned on eight corners (in detail, the inner sides of the corners) of the stack-type battery 100.

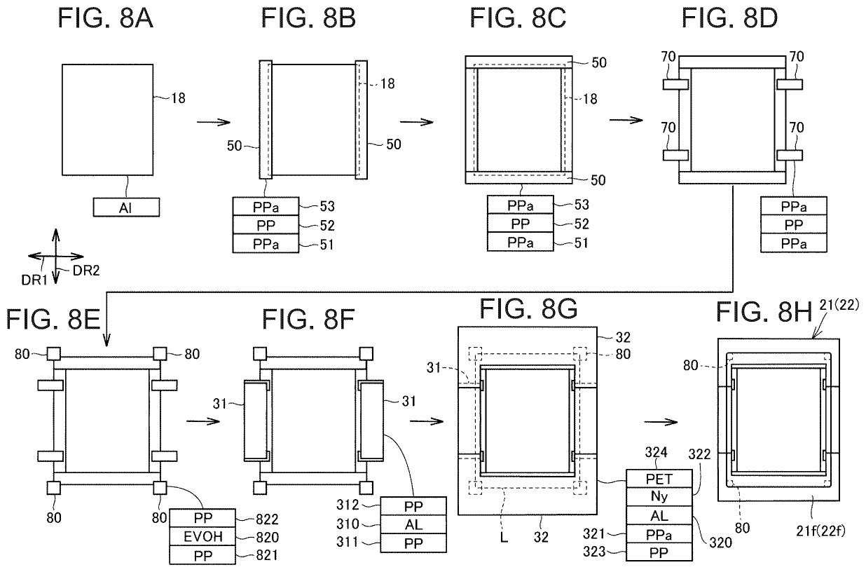

The four protection sheets 80 on the first laminate sheet portion 21 side are covered with the second sheets 32 of the first laminate sheet portion 21 described later (the state in FIG. 8G). The four protection sheets 80 of the second laminate sheet portion 22 are also covered with the second sheets 32 of the second laminate sheet portion 22 from the outer side.

The second sheets 32 of the first laminate sheet portion 21 have a main wall portion 251 and peripheral wall portions 252. Similarly, the second sheets 32 of the second laminate sheet portion 22 have the main wall portion 251 and the peripheral wall portions 252 as well. The main wall portion 251 is parallel to the first main surface 91 of the electricity storage module 1. The peripheral wall portions 252 are parallel to the peripheral surfaces 93 of the electricity storage module 1.

The stacked electrode body 10 includes the plurality of electrode plates 11, a plurality of separators 15, a positive-electrode terminal end electrode 16, and a negative-electrode terminal end electrode 17. The plurality of electrode plates 11, the positive-electrode terminal end electrode 16, and the negative-electrode terminal end electrode 17 are stacked in the stacking direction (the DR3 direction in FIG. 2 and FIG. 3) via the separators 15.

The separators 15 are formed in a sheet-like manner. Examples of the separators 15 include a porous film formed by polyolefin resin such as polyethylene (PE) and polypropylene (PP) and a woven fabric or a non-woven fabric formed by polypropylene, methylcellulose, and the like. The separators 15 may be reinforced by a fluorinated vinylidene resin compound.

The plurality of electrode plates 11 is provided between the positive-electrode terminal end electrode 16 and the negative-electrode terminal end electrode 17. The electrode plates 11 are bipolar electrodes, for example. The electrode plates 11 include a current collector 12, a positive electrode layer 13, and a negative electrode layer 14.

The current collector 12 may contain at least one type selected from a group formed by aluminum (Al), stainless steel, nickel (Ni), chromium (Cr), platinum (Pt), niobium (Nb), iron (Fe), titanium (Ti), and zinc (Zn), for example. The current collector 12 may be obtained by applying a plating process on a front surface of a metallic foil.

The current collector 12 has a first surface 12a positioned on one side in the stacking direction and a second surface 12b positioned on the other side in the stacking direction. The negative electrode layer 14 is provided on the first surface 12a. The positive electrode layer 13 is provided on the second surface 12b.

The positive-electrode terminal end electrode 16 is positioned on one side in the stacking direction. The positive-electrode terminal end electrode 16 includes the current collector 12 and the positive electrode layer 13. Specifically, in the positive-electrode terminal end electrode 16, the negative electrode layer 14 and the positive electrode layer 13 are not provided on the first surface 12a of the current collector 12, and the positive electrode layer 13 is provided on the second surface 12b of the current collector 12. The first conductive plate 18 is disposed on the first surface 12a of the current collector 12 in the positive-electrode terminal end electrode 16. A central portion (a part besides a peripheral edge portion) of the first surface 12a of the current collector 12 in the positive-electrode terminal end electrode 16 configures a part of the first main surface 91. The first main surface 91 includes the central portion of the first surface 12a of the current collector 12 in the positive-electrode terminal end electrode 16 and an upper surface of the resin sealing body 40.

The negative-electrode terminal end electrode 17 is positioned on the other side in the stacking direction. The negative-electrode terminal end electrode 17 includes the current collector 12 and the negative electrode layer 14. Specifically, in the negative-electrode terminal end electrode 17, the negative electrode layer 14 is provided on the first surface 12a of the current collector 12, and the negative electrode layer 14 and the positive electrode layer 13 are not provided on the second surface 12b of the current collector 12. The second conductive plate 19 is disposed on the second surface 12b of the current collector 12 in the negative-electrode terminal end electrode 17. A central portion (a part besides a peripheral edge portion) of the second surface 12b of the current collector 12 in the negative-electrode terminal end electrode 17 configures a part of the second main surface 92. The second main surface 92 includes the central portion of the second surface 12b of the current collector 12 in the negative-electrode terminal end electrode 17 and a lower surface of the resin sealing body 40.

The positive electrode layer 13 is formed as a result of a positive-electrode active material being applied to the second surface 12b. As the positive-electrode active material, a positive-electrode active material that may occlude and release a charge carrier such as lithium ion can be employed, for example. Specifically, as the positive-electrode active material, a lithium ion composite metal oxide having a layered rock salt structure, metal oxide having a spinel structure, a polyanionic compound, and the like that can be used as a positive-electrode active material of a lithium ion secondary battery can be employed. Two or more types of positive-electrode active materials may be used together, and the positive-electrode active material may contain olivine-type lithium iron phosphate (LiFePO4), for example.

The negative electrode layer 14 is formed as a result of a negative-electrode active material being applied to the first surface 12a. As the negative-electrode active material, lithium, carbon, a metal compound, and an element that can be alloyed with lithium, a compound thereof, or the like, for example, can be employed.

In all of the plurality of electrode plates 11, the negative-electrode terminal end electrode 17, and the positive-electrode terminal end electrode 16, a peripheral edge portion of the current collector 12 is an uncoated region in which the positive electrode layer 13 and the negative electrode layer 14 are not provided.

The resin sealing body 40 is provided so as to seal the periphery of the stacked electrode body 10. Specifically, the resin sealing body 40 seals a cell space formed between two adjacent electrode plates 11. An electrolytic solution is injected into the cell space. In other words, an electrolytic solution is injected into the electricity storage module 1. The resin sealing body 40 is formed by curing resin members such as a hotmelt member, a thermoplastic resin, a thermosetting resin or a photocurable resin. The resin sealing body 40 is provided on the uncoated region described above.

The first conductive plate 18 and the second conductive plate 19 are provided so as to sandwich the stacked electrode body 10 in the stacking direction. Specifically, the first conductive plate 18 is disposed on the first surface 12a of the current collector 12 included in the positive-electrode terminal end electrode 16. In other words, the first conductive plate 18 is disposed on the first main surface 91 of the current collector 12 included in the positive-electrode terminal end electrode 16. The first conductive plate 18 is electrically connected to the positive-electrode terminal end electrode 16 by being disposed in abutment against the first surface 12a. The first conductive plate 18 functions as a positive-electrode terminal of the stack-type battery 100 by being electrically connected to the positive-electrode terminal end electrode 16.

The second conductive plate 19 is disposed on the second surface 12b of the current collector 12 included in the negative-electrode terminal end electrode 17. In other words, the second conductive plate 19 is disposed on the second main surface 92 of the current collector 12 included in the negative-electrode terminal end electrode 17. The second conductive plate 19 is electrically connected to the negative-electrode terminal end electrode 17 by being disposed in abutment against the second surface 12b. The second conductive plate 19 functions as a negative-electrode terminal of the stack-type battery 100 by being electrically connected to the negative-electrode terminal end electrode 17.

In the stack-type battery 100, current can be taken to the outside from the electricity storage module 1 housed on the inside via the first conductive plate 18 that functions as a positive-electrode terminal and the second conductive plate 19 that functions as a negative-electrode terminal without using a tab for taking out the current to the outside.

The first conductive plate 18 and the second conductive plate 19 have a rectangular shape having a plurality of corner portions. Peripheral edges of the first conductive plate 18 and the second conductive plate 19 are positioned on the resin sealing body 40.

In this example, the first conductive plate 18 and the second conductive plate 19 are aluminum (Al) plates. The first conductive plate 18 and the second conductive plate 19 are not limited thereto and may contain at least one type selected from a group formed by aluminum (Al), stainless steel, nickel (Ni), chromium (Cr), platinum (Pt), niobium (Nb), iron (Fe), titanium (Ti), and zinc (Zn). The current collector 12 may be obtained by applying a plating process on a front surface of a metallic foil.

The first laminate sheet portion 21 is joined to a peripheral edge of the first conductive plate 18. The first laminate sheet portion 21 is joined to the first conductive plate 18 in a state in which the resin sheet 50 is interposed between the first laminate sheet portion 21 and the peripheral edge of the first conductive plate 18. The second laminate sheet portion 22 is joined to a peripheral edge of the second conductive plate 19. The second laminate sheet portion 22 is joined to the second conductive plate 19 in a state in which the resin sheet 50 is interposed between the second laminate sheet portion 22 and the peripheral edge of the second conductive plate 19.

In this example, the resin sheet 50 is formed by a resin material having an insulation property. The resin sheet 50 is formed by a resin material that can be welded to the first conductive plate 18 and the second conductive plate 19. In this example, the resin sheet 50 is an insulation sealant film.

In detail, the resin sheet 50 has resin layers 51, 52, 53. The resin layer 51 is a layer on the inner side. The resin layer 53 is a layer on the outer side. The resin layer 52 is sandwiched between the resin layer 51 and the resin layer 53.

The resin layers 51, 53 are sealant resin layers. As also shown in the states of FIG. 8B and FIG. 8C described later, the resin layers 51, 53 are acid-modified (PPa) layers in this example. The resin layer 51 is thermally welded to the first conductive plate 18. The resin layer 52 is a polypropylene (PP) layer in this example.

The type of the resin configuring each of the resin layers 51 to 53 is not limited to the above, and heat-fusible resin such as polyethylene, polypropylene, modified polyethylene, and modified polypropylene, for example, can be used, as appropriate.

A central portion of the first conductive plate 18 and a central portion of the second conductive plate 19 are exposed regions that are not covered by the resin sheet 50, the first laminate sheet portion 21, and the second laminate sheet portion 22. Current can be directly taken from the electricity storage module 1 housed on the inside to the outside via the exposed regions.

The first laminate sheet portion 21 includes the plurality of first sheets 31 and the plurality of second sheets 32 (see FIGS. 2, 3, and 6). The plurality of first sheets 31 and the plurality of second sheets 32 cover the peripheral edge of the first conductive plate 18 in cooperation with each other. The second laminate sheet portion 22 includes the plurality of first sheets 31 and the plurality of second sheets 32. The plurality of first sheets 31 and the plurality of second sheets 32 included in the second laminate sheet portion 22 cover the peripheral edge of the second conductive plate 19 in cooperation with each other.

The first sheets 31 (see FIG. 2) have the first metal layer 310 and sealant resin layers 311, 312. The first metal layer 310 has a sheet-like shape. In this example, as also shown in the state of FIG. 8E described later, the first metal layer 310 is an aluminum foil (Al foil) layer. The first metal layer 310 is not limited to an Al foil and metal foils such as a Ni foil, a Cu foil, and a stainless steel foil can also be used. The first metal layer 310 gives moisture transmission resistance, air permeation resistance, and chemical resistance to the first sheets 31.

The sealant resin layers 311, 312 are provided on both surfaces of the first metal layer 310. Specifically, the sealant resin layer 311 is provided on an inner front surface of the first metal layer 310. The sealant resin layer 312 is provided on an outer front surface of the first metal layer 310.

The sealant resin layers 311, 312 have compatibility with the resin sheet 50. In this example, polypropylene (PP) is employed as the sealant resin layers 311, 312 but the present disclosure is not limited to thereto, and heat-fusible resin such as polyethylene, polypropylene, modified polyethylene, and modified polypropylene, for example, may be employed as the sealant resin layers 311, 312.

The sealant resin layers 311, 312 function as seal layers of the exterior body 20. The sealant resin layers 311, 312 also have a function as insulation layers and insulate the first laminate sheet portion 21 and the second laminate sheet portion 22 from each other when the first laminate sheet portion 21 and the second laminate sheet portion 22 are joined to each other.

The second sheets 32 (see FIG. 3) have a second metal layer 320, a first resin layer 321, a second resin layer 322, a third resin layer 323, and a fourth resin layer 324. In the second sheets 32, the third resin layer 323, the first resin layer 321, the second metal layer 320, the second resin layer 322, and the fourth resin layer 324 are stacked from the inner side to the outer side of the stack-type battery 100 in the stated order. The fourth resin layer 324 is an outermost layer in the second sheets 32.

In this example, as also shown in the state of FIG. 8F described later, the second metal layer 320 is an Al foil layer. The first resin layer 321 is an acid-modified (PPa) layer. The second resin layer 322 is a nylon layer. The third resin layer 323 is a polypropylene (PP) layer. The fourth resin layer 324 that is an outermost layer is a polyethylene terephthalate (PET) layer. The first resin layer 321 is provided on a first main surface 320a. The second resin layer 322 is provided on a second main surface 320b.

The second metal layer 320 has a sheet-like shape. The second metal layer 320 has the first main surface 320a and the second main surface 320b. The first main surface 320a is a surface that faces the inner side (the side on which the stacked electrode body 10 is positioned), and the second main surface 320b is a surface that faces the outer side (the opposite side from the side on which the stacked electrode body 10 is positioned).

The second metal layer 320 is not limited to an Al foil and metal foils such as a Ni foil, a Cu foil, and a stainless steel foil can be used. The thickness of the second metal layer 320 may be thicker than the thickness of the first metal layer 310. The thickness of the second metal layer 320 may be the same as the thickness of the first metal layer 310.

The third resin layer 323 has compatibility with the sealant resin layer 312. As the third resin layer 323, heat-fusible resin such as polyethylene, modified polyethylene, and modified polypropylene, for example, can be employed besides polypropylene (PP). A resin material having immiscibility against the sealant resin layer 312 may be used in the fourth resin layer 324.

In the second sheets 32, a nylon layer (second resin layer 322) and a polyethylene terephthalate layer (fourth resin layer 324) are caused to overlap on the outer side of the second metal layer 320. Therefore, the combination of the layers on the outer side of the second metal layer 320 has a higher strength than the combination of the two layers (the first resin layer 321 and the third resin layer 323) on the inner side of the second metal layer 320 in the second sheets 32. The expression of “high strength” means that the rigidity or the tensile strength is high. As a result, the damage of the second metal layer 320 when the second sheets 32 receive force from the outside such as piercing can be suitably prevented.

The sealant resin layer 312 of the first sheets 31 (see FIG. 2) is a polypropylene (PP) layer as described above. Therefore, the combination of the layers on the outer side of the second metal layer 320 of the second sheets 32 has a higher strength than the sealant resin layer 312 of the first sheets 31. Therefore, the combination of the layers on the outer side of the second metal layer 320 in the second sheets 32 has a higher strength than the sealant resin layer 312 of the first sheets 31. By enhancing the strength of the second sheets 32, the damage of the second sheets 32 at the time of deep-drawing molding described later can be suitably prevented.

The first laminate sheet portion 21 is deep-drawing molded in a state of being joined to the first conductive plate 18. In other words, a drawing process is applied to the first laminate sheet portion 21. As a result, the first laminate sheet portion 21 has a shape that is opened toward the upper side and the lower side. A flange portion 21f bent to the outer side is provided on an opening end of the first laminate sheet portion 21 on the lower side thereof.

The second laminate sheet portion 22 is deep-drawing molded in a state of being joined to the second conductive plate 19. In other words, a drawing process is also applied to the second laminate sheet portion 22 as with the first laminate sheet portion 21. As a result, the second laminate sheet portion 22 has a shape that is opened toward the upper side and the lower side. A flange portion 22f bent to the outer side is provided on an opening end of the second laminate sheet portion 22 on the upper side thereof.

Housing recessed portions 21c, 22c for housing the electricity storage module 1 on the inner side are provided on the first laminate sheet portion 21 and the second laminate sheet portion 22. A part of the first main surface 91, a part of the second main surface 92, and the peripheral surfaces 93 in the electricity storage module 1 are covered by the housing recessed portions 21c, 22c.

In detail, a peripheral edge portion of an upper surface and a peripheral edge portion of a lower surface of the electricity storage module 1 and a peripheral surface of the electricity storage module 1 are covered by the housing recessed portions 21c, 22c. In detail, a peripheral edge portion of an upper surface and a peripheral edge portion of a lower surface of the stacked electrode body 10 and a peripheral surface of the stacked electrode body 10 are covered by the housing recessed portions 21c, 22c. A central portion of the upper surface of the stacked electrode body 10 is covered by the first conductive plate 18. A central portion of the lower surface of the stacked electrode body 10 is covered by the second conductive plate 19.

The housing recessed portions 21c, 22c are configured by a section formed by applying the drawing process described above to the first laminate sheet portion 21 and the second laminate sheet portion 22, for example. The housing recessed portions 21c, 22c are not limited to the section and only need to be provided to be able to house the stacked electrode body 10. In the description above, a case in which the housing recessed portions are provided in both of the first laminate sheet portion 21 and the second laminate sheet portion 22 has been exemplified, but the housing recessed portion may be provided in only one of the first laminate sheet portion 21 and the second laminate sheet portion 22.

The first sheets 31 have an inner-side end portion 31i positioned on the central side of the stacked electrode body 10. The second sheets 32 have an inner-side end portion 32i positioned on the central side of the stacked electrode body 10. The resin sheet 50 has an inner edge portion 50i and an outer edge portion 50c positioned on the central side of the stacked electrode body 10.

The inner edge portion 50i is positioned to be closer to the central side of the stacked electrode body 10 than the inner-side end portions 31i, 32i in order to secure an insulation distance between the first metal layer 310 of the first sheets 31 and the second metal layer 320 of the second sheets 32, and the first conductive plate 18 and the second conductive plate 19.

The first conductive plate 18 has an outer edge portion 18c. The second conductive plate 19 has an outer edge portion 19c. The inner-side end portions 31i, 32i are positioned to be closer to the central side of the stacked electrode body 10 than the outer edge portions 18c, 19c.

Parts in which the first conductive plate 18 and the second conductive plate 19 and the resin sheet 50 overlap are welded. Joining interfaces of the overlapping parts are sealed.

The outer edge portion 50c of the resin sheet 50 is positioned on the outer side of the outer edge portions 18c, 19c but is not limited thereto, and the outer edge portion 50c and the outer edge portions 18c, 19c may be flush with each other.

By joining the first sheets 31 and the second sheets 32 to the first conductive plate 18 and the second conductive plate 19 via the resin sheet 50, cases in which the first conductive plate 18 and the second conductive plate 19 short via the first sheets 31 having the first metal layer 310 or the second sheets 32 having the second metal layer 320 are reduced.

Next, the structure body 60 is described. As described above, the structure body 60 is housed in the exterior body 20. As shown in FIG. 3, the structure body 60 is disposed in a state of facing the peripheral surfaces 93 (in detail, the end surfaces 93a, 93c) of the electricity storage module 1.

FIG. 4 is a perspective view of the structure body 60. As shown in FIG. 4, the structure body 60 has a box-like shape in this example. The structure body 60 is typically formed by resin. The structure body 60 includes a base portion 61 extending in the DR3 direction in side view (see FIG. 3) of the electricity storage module 1.

The structure body 60 further includes two wall portions 62, 64 extending from the base portion 61 to be parallel to the first main surface 91 of the electricity storage module 1 and to be in the DR2 direction toward the peripheral surface 93. The structure body 60 further includes two wall portions 63, 65 extending from the base portion 61 to be perpendicular to the first main surface 91 and to be in the DR2 direction toward the peripheral surface 93.

The wall portions 62, 63, 64, 65 that rise from the base portion 61 are consecutive to each other in the stated order. The wall portion 62 is positioned on the first conductive plate 18 side. The wall portion 64 is positioned on the second conductive plate 19 side. A cuboid space 690 having an opening portion is formed by the base portion 61 and each of wall portions 62, 63, 64, 65.

The structure body 60 has outer front surfaces 60s and inner front surfaces 60t on the peripheral surface 93 side of the outer front surfaces 60s. The first and second laminate sheet portions 21, 22 (see FIG. 1) configuring the exterior body 20 are disposed so as to cover the outer front surfaces 60s of the structure body 60. In detail, each of the second sheets 32 (see FIG. 3) of the first and second laminate sheet portions 21, 22 are disposed so as to cover the outer front surfaces 60s of the structure body 60.

A sealed inner space 800 is formed as shown in FIG. 3 by each of the second sheets 32 of the first and second laminate sheet portions 21, 22 between the inner front surface 60t of the part of the base portion 61 in the structure body 60 and the end surface 93a of the electricity storage module 1. The inner space 800 is depressurized so as to have a negative pressure with respect to the air pressure (the atmospheric pressure in this example) of an outer space of the stack-type battery 100. In this example, the inner space 800 is depressurized to about 1 kilopascal (kPa) in the initial state. The inner space 800 is placed in a low-vacuum state by vacuum drawing. A binding force is applied to the stacked electrode body 10 by the pressure difference between the inner space 800 and the outer space of the stack-type battery 100 generated by such depressurization.

As above, the stack-type battery 100 that is one example of the electricity storage apparatus includes the electricity storage module 1 having the stacked electrode body 10 and having the first and second main surfaces 91, 92 and the peripheral surfaces 93 perpendicular to the first and second main surfaces 91, 92. As shown in FIG. 2 and FIG. 3, the stack-type battery 100 further includes the exterior body 20 that houses the electricity storage module 1. As shown in FIGS. 3 and 4, the exterior body 20 includes the structure body 60 having the outer front surfaces 60s and the inner front surfaces 60t on the peripheral surface 93 side of the outer front surfaces 60s and disposed in a state of facing the peripheral surfaces 93.

As shown in FIG. 3, the exterior body 20 further includes the first and second laminate sheet portions 21, 22 disposed to cover the outer front surfaces 60s. As shown in FIG. 3, the sealed inner space 800 is formed between the inner front surfaces 60t and the peripheral surfaces 93 by the first and second laminate sheet portions 21, 22. The inner space 800 is depressurized so as to have a negative pressure with respect to the air pressure of an outer space of the stack-type battery 100.

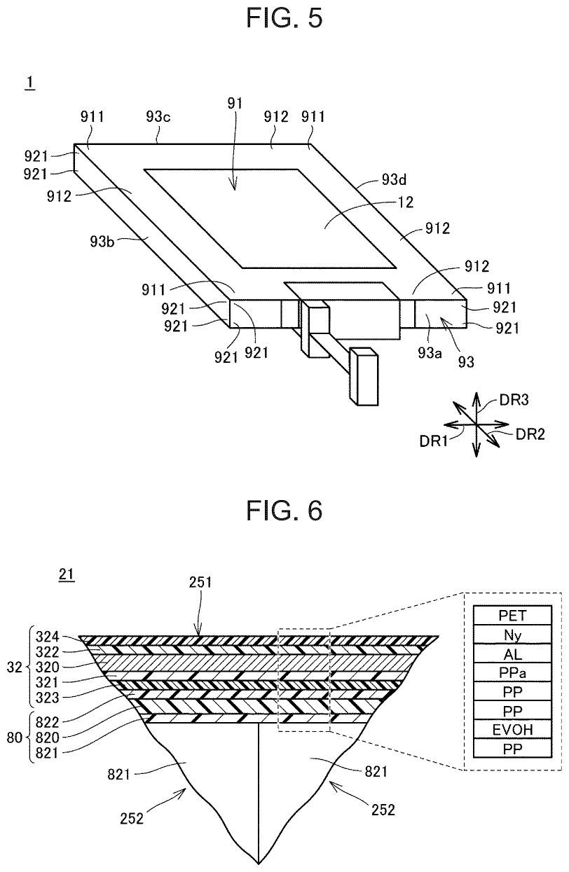

FIG. 5 is a perspective view of the electricity storage module 1. As shown in FIG. 5, the electricity storage module 1 includes the first main surface 91 and the peripheral surfaces 93. As described above, the electricity storage module 1 further includes the second main surface 92 (FIG. 2 and FIG. 3) on the side opposite from the first main surface 91. The peripheral surfaces 93 are configured by the four rectangular-shaped end surfaces 93a to 93d. The direction of the normal of the first main surface 91 and the second main surface 92 is the DR3 direction. The peripheral surfaces 93 extend from the first main surface 91 or the second main surface 92 in the DR3 direction.

The first main surface 91 has a plurality of corner portions 911, and a plurality of edge portions 912 each sandwiched between two of the corner portions 911. In this example, the first main surface 91 has four corner portions 911 and four edge portions 912.

As described above, the peripheral surfaces 93 has the plurality of end surfaces 93a to 93d consecutive in the peripheral direction of the electricity storage module 1. Each of the end surfaces 93a to 93d has a plurality of corner portions 921 each connected to each of the corner portions 911 different from each other. In this example, each of the end surfaces 93a to 93d has four corner portions 921. Each of two corner portions 921 on the first main surface 91 side out of the four corner portions 921 is connected to a different one of the corner portions 911 of the first main surface 91. One corner (in detail, a three-dimensional corner) of the electricity storage module 1 is configured by one corner portion 911 and two corner portions 921 (in detail, two consecutive corner portions 921 of different end surfaces) connected to the corner portion 911.

As with the first main surface, the second main surface 92 also has four corner portions 911 and four edge portions 912. Each of two corner portions 921 on the second main surface 92 side out of the four corner portions 921 of the end surfaces 93a to 93d is connected to a different one of the corner portions 911 of the second main surface 92.

FIG. 6 is a sectional view taken along line VI-VI shown in FIG. 1. As shown in FIG. 6, the first laminate sheet portion 21 has the second sheets 32 and the protection sheets 80. As described above, in the second sheets 32, the third resin layer 323, the first resin layer 321, the second metal layer 320, the second resin layer 322, and the fourth resin layer 324 are stacked from the inner side to the outer side of the stack-type battery 100 in the stated order.

The protection sheets 80 are disposed between the corner portion 911 and the plurality of corner portions 921 connected to the corner portion 911, and the second sheets 32. The protection sheets 80 are resin barrier films. The resin barrier film includes resin having a high gas barrier property.

Resin containing vinyl alcohol such as EVOH and polyvinyl alcohol (PVA) as a monomer exhibits a high gas barrier property because molecules can be aggregated in a compact manner. A resin barrier film obtained by performing multi-layering of such gas barrier resin on resin of which moisture transmission degree is low such as PP and PE used in sealant resin curbs (shields) transmission of air and an electrolytic solution (gas) that leaks out via a resin seal portion of the module. Resin barrier films as above are used as the protection sheets 80.

The protection sheets 80 are stronger to a thermal shock than the second metal layer 320. The protection sheets 80 have a second resin layer 821, a first resin layer 820, and a third resin layer 822 from the inner side to the outer side of the stack-type battery 100 in the stated order. The first resin layer 820 is an ethylene-vinyl alcohol copolymer (EVOH) layer. The second resin layer 821 and the third resin layer 822 are polypropylene (PP) layers.

The protection sheets 80 are welded to the second sheets 32. In detail, the protection sheets 80 are welded to the third resin layer 323 of the second sheets 32. In more detail, the third resin layer 822 of the protection sheets 80 and the third resin layer 323 of the second sheets 32 are welded to each other.

The main wall portion 251 of the first laminate sheet portion 21 (see FIG. 1 to FIG. 3) cover each corner portion 911 of the first main surface 91 and each edge portion 912 of the first main surface 91. The peripheral wall portions 252 of the first laminate sheet portion 21 cover each of the end surfaces 93a to 93d. Similarly, the main wall portion 251 of the second laminate sheet portion 22 covers each corner portion 911 of the second main surface 92 and each edge portion 912 of the second main surface 92. The peripheral wall portions 252 of the second laminate sheet portion 22 cover each of the end surfaces 93a to 93d.

Each of the protection sheets 80 are provided in a position corresponding to the corner portion 911 and two of the corner portions 921 each connected to the corner portion 911 out of a border region R (see FIG. 2 and FIG. 3) between the main wall portion 251 and the peripheral wall portions 252. In detail, as one example, the corner portion 911 of the first main surface 91, the corner portion 921 of the end surface 93b of the peripheral surfaces 93, and the corner portion 921 of the end surface 93c of the peripheral surfaces 93 face the second resin layer 821 of the protection sheets 80 (a part of the second resin layer 821 shown in FIG. 6).

The stack-type battery 100 has a configuration as below when the first main surface 91 out of the first main surface 91 and the second main surface 92 is focused on by the above.

As shown in FIG. 2 and FIG. 3, the stack-type battery 100 includes the electricity storage module 1 having the stacked electrode body 10 in which the plurality of electrodes is stacked in the DR3 direction (stacking direction), and the exterior body 20 that houses the electricity storage module 1. The electricity storage module 1 includes the first main surface 91 of which the normal direction is the DR3 direction, and the peripheral surfaces 93 extending from the first main surface 91 in the DR3 direction.

As shown in FIG. 5, the first main surface 91 has the plurality of corner portions 911, and the plurality of edge portions 912 each sandwiched between two of the corner portions 911. The peripheral surfaces 93 has the plurality of end surfaces 93a to 93d consecutive in the peripheral direction of the electricity storage module 1. Each of the end surfaces 93a to 93d has a plurality of corner portions 921 each connected to each of the corner portions 911 different from each other.

As shown in FIG. 1 and FIG. 6, the exterior body 20 includes the second sheets 32 having the second metal layer 320, and the plurality of protection sheets 80 each welded to the second sheets 32. The second sheets 32 have the main wall portion 251 that covers each of the corner portions 911 and each of the edge portions 912 of the electricity storage module 1 shown in FIG. 5, and the peripheral wall portions 252 that covers each of the end surfaces 93a to 93d of the electricity storage module 1. Each of the protection sheets 80 are provided in a position corresponding to the corner portion 911 and the plurality of corner portions 921 each connected to the corner portion 911 out of the border region R (FIG. 2 and FIG. 3) between the main wall portion 251 and the peripheral wall portions 252.

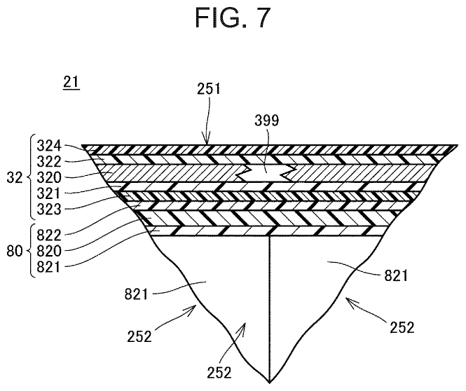

FIG. 7 is a sectional view taken along line VI-VI shown in FIG. 1 after a thermal shock is applied. As shown in FIG. 7, a crack 399 occurs in the second metal layer 320 of the second sheet 32 due to a thermal shock. When the crack 399 occurs, the sealing property of the second sheet 32 is lost.

A crack occurs in the second metal layer 320 due to a thermal shock in an easier manner in a position (hereinafter also referred to as a “nook position”) corresponding to the corner portion 911 and the plurality of corner portions 921 each connected to the corner portion 911 out of the border region R (FIG. 2 and FIG. 3) between the main wall portion 251 and the peripheral wall portions 252 as compared to other positions. Thus, by providing the protection sheets 80 in the nook position as shown in FIG. 6 and FIG. 7, the sealing property of the first laminate sheet portion 21 can be ensured even when the crack 399 occurs. This point can also be said for the second laminate sheet portion 22. As above, according to the stack-type battery 100, the sealing property of the stack-type battery 100 can be maintained even when a thermal shock is applied.

Each of the protection sheets 80 is a resin barrier film stronger to a thermal shock than the second metal layer 320 and is covered with the second sheets 32. Therefore, the electrolytic solution injected into the electricity storage module 1 can be prevented from entering the second sheets 32.

FIG. 8A, FIG. 8B, FIG. 8C, FIG. 8D, FIG. 8E, FIG. 8F, FIG. 8G, and FIG. 8H are views for describing a manufacturing method of the first laminate sheet portion 21. As shown in the state of FIG. 8A, an aluminum plate that serves as the first conductive plate 18 is prepared. As shown in the state of FIG. 8B, two resin sheets 50 are welded along two long edges of the aluminum plate. Next, as shown in the state of FIG. 8C, two resin sheets 50 are welded along two short edges of the aluminum plate. The resin sheets 50 on the long edge side and the resin sheets 50 on the short edge side overlap at four corner portions shown in the state of FIG. 8C.

As shown in the state of FIG. 8D, two resin sheets 70 are welded to each of the two resin sheets 50 on the long edge side. Each of the resin sheets 70 has the same structure as the resin sheet 50 in this example. The two resin sheets 70 on the right side of the drawing are spaced apart from each other in the DR2 direction and extend in the D1 direction. Similarly, the two resin sheets 70 on the left side of the drawing are also spaced apart from each other in the DR2 direction and extend in the D1 direction. The four resin sheets 70 are welded to the resin sheets 50 on the long edge side in a state of sticking out from the resin sheets 50 in directions on the sides opposite from the aluminum plate.

As shown in the state of FIG. 8E, the protection sheets 80 are welded to each of the four corner portions of the intermediate body of the first laminate sheet portion 21 shown in the state of FIG. 8D. In detail, the protection sheets 80 are welded to both of longitudinal-direction end portions of the two resin sheets 50 on the short edge side. In other words, the protection sheets 80 are welded to the upper and lower resin sheets 50 in the drawing. The four protection sheets 80 are welded to the resin sheet 50.

As shown in the state of FIG. 8F, one first sheet 31 is welded to the resin sheet 50 and the two resin sheets 70 on the right side of the drawing. Similarly, one first sheet 31 is also welded to the resin sheet 50 and the two resin sheets 70 on the left side of the drawing. Each first sheet extends in the DR2 direction. Each first sheet is longer than a separation distance between the resin sheets 70 in the DR2 direction.

As shown in the state of FIG. 8G, one second sheet 32 is welded to the resin sheet 50 on the upper side in the drawing, the two resin sheets 70 on the upper side in the drawing, end portions (end portions on the upper side in the drawing) of the two first sheets 31, and the two protection sheets 80 on the upper side in the drawing. The second sheet 32 has a U-like shape. Similarly, one second sheet 32 is also welded to the resin sheet 50 on the lower side in the drawing, the two resin sheets 70 on the lower side in the drawing, end portions (end portions on the lower side in the drawing) of the two first sheets 31, and the two protection sheets 80 on the lower side of the drawing. The second sheets 32 are placed in a state of facing the DR2 direction by being spaced apart from each other. An intermediate body of the first laminate sheet portion 21 shown as the state of FIG. 8G is line-symmetric in each of the DR1 direction and the DR2 direction.

By applying a drawing process on the intermediate body along a virtual line L, the first laminate sheet portion 21 is generated as shown in the state of FIG. 8H. By the drawing process, the flange portion 21f of the first laminate sheet portion 21 is formed. In a top view of the intermediate body of the first laminate sheet portion 21 shown in the state of FIG. 8G, the virtual line L overlaps with each of the protection sheets 80. Therefore, as shown in the state of FIG. 8H and FIG. 1, each of the protection sheets 80 is positioned on the inner side (nook portion) of the corner of the first laminate sheet portion 21.

The first laminate sheet portion 21 and the second laminate sheet portion 22 have the same shapes. The second laminate sheet portion 22 is also manufactured by a method similar to that of the first laminate sheet portion 21. Therefore, here, the description of the manufacturing method of the second laminate sheet portion 22 is not repeated.

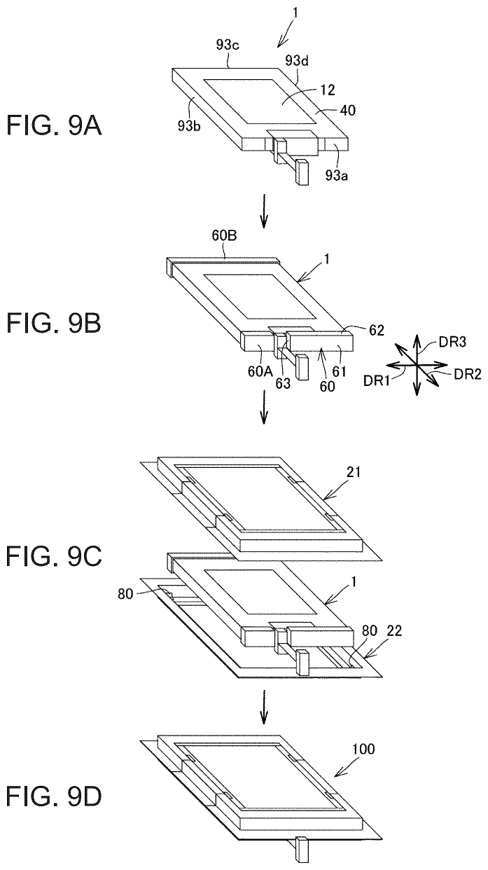

FIG. 9A, FIG. 9B, FIG. 9C, and FIG. 9D are views for describing a method of manufacturing the stack-type battery 100 by the electricity storage module 1, the structure body 60, and the exterior body 20. As shown in the states of FIG. 9A and FIG. 9B, the structure body 60 is installed on one of the two short edge sides of the electricity storage module 1. The structure body 60 is installed in a position facing the end surface 93a configuring the peripheral surfaces 93 of the electricity storage module 1.

In this example, the stack-type battery 100 further includes structure bodies 60A, 60B. The structure bodies 60A, 60B have structures and functions similar to those of the structure body 60. The length of the structure body 60A in the DR1 direction is shorter than that of the structure body 60. The length of the structure body 60B in the DR1 direction is longer than that of the structure body 60. As with the structure body 60, the structure bodies 60A, 60B are housed in the exterior body 20.

The structure body 60A is installed on the same side as the structure body 60. As with the structure body 60, the structure body 60A is installed such that the opening side faces the end surface 93a. The structure body 60B is installed on a short edge on the opposite side from the structure body 60. The structure body 60B is installed in a position that faces the end surface 93c of the electricity storage module 1. In detail, the structure body 60B is installed such that the opening side faces the end surface 93c.

As shown in the state of FIG. 9C, the electricity storage module 1 and the three structure bodies 60, 60A, 60B are sandwiched by the first laminate sheet portion 21 and the second laminate sheet portion 22. The second laminate sheet portion 22 is in a state of facing down. Then, the first laminate sheet portion 21 and the second laminate sheet portion 22 are welded to each other. As a result, the stack-type battery 100 is completed as shown in the state of FIG. 9D.

### MODIFIED EXAMPLES

In the description above, as shown in the state of FIG. 8G and FIG. 1, the protection sheets 80 are provided on the inner side of the second sheets 32. However, the present disclosure is not limited to the above. The protection sheets 80 may be provided on the outer side of the second sheets 32.

The embodiment disclosed above is merely an example in all aspects and in no way intended to limit the disclosure. The scope of the disclosure is defined by the scope of claims. All modifications made within the scope and spirit equivalent to those of the claims are included in the disclosure.

What is claimed is:

1. An electricity storage apparatus, comprising:
an electricity storage module having a stacked electrode body in which a plurality of electrodes is stacked in a predetermined direction; and
an exterior body that houses the electricity storage module, wherein:
the electricity storage module includes:
a main surface of which a normal direction is the predetermined direction; and
a peripheral surface extending from the main surface in the predetermined direction;
the main surface has:
a plurality of first corner portions; and
a plurality of edge portions each sandwiched between two of the first corner portions;
the peripheral surface has a plurality of end surfaces consecutive in a peripheral direction of the electricity storage module;
each of the end surfaces has a plurality of second corner portions each connected to a different one of the first corner portions;
the exterior body includes:
a laminate sheet having a metal layer; and
a plurality of protection sheets each welded to the laminate sheet;
the laminate sheet has:
a main wall portion that covers each of the first corner portions and each of the edge portions; and
a peripheral wall portion that covers each of the end surfaces; and
each of the protection sheets is provided in a position corresponding to the first corner portion and the plurality of second corner portions each connected to the first corner portion out of a border region between the main wall portion and the peripheral wall portion.

2. The electricity storage apparatus according to claim 1, wherein each of the protection sheets is a resin barrier film stronger to a thermal shock than the metal layer and is covered with the laminate sheet.
